(19) United States
(12) Patent Application Publication
(10) Pub. No.: US 2012/0115473 A1
(43) Pub. Date: May 10, 2012

(54) METHOD AND APPARATUS FOR SUPPORTING LOCATION INFORMATION IN MACHINE TO MACHINE COMMUNICATION SYSTEM

(75) Inventors: Young-Sung Kho, Seongnam-si (KR); Bo-Hyun Kang, Seoul (KR)

(73) Assignee: SAMSUNG ELECTRONICS CO., LTD., Suwon-si (KR)

(21) Appl. No.: 13/284,659

(22) Filed: Oct. 28, 2011

(30) Foreign Application Priority Data
Nov. 4, 2010 (KR) 10-2010-0109379

(51) Int. Cl. H04W 24/00; H04W 60/00

(52) U.S. Cl. 455/435.1; 455/456.1; 455/457

(57) ABSTRACT

A method for synchronizing location information between devices in a Machine to Machine (M2M) communication system includes, when receiving a location information synchronization request for a plurality of devices, determining whether location information of a corresponding device among the plurality of devices is present; when the location information of the corresponding device is not present, requesting location information to the corresponding device and receiving the location information of the corresponding device; and transmitting the received location information of the corresponding device to the other devices excluding the corresponding device among the plurality of devices.

### CROSS-REFERENCE TO RELATED APPLICATION(S) AND CLAIM OF PRIORITY

The present application is related to and claims the benefit under 35 U.S.C. §119 to a Korean patent application filed in the Korean Intellectual Property Office on Nov. 4, 2010, and assigned Serial No. 10-2010-0109379, the contents of which is herein incorporated by reference.

### TECHNICAL FIELD OF THE INVENTION

The present invention relates generally to Machine to Machine (M2M) communication. More particularly, the present invention relates to a method and an apparatus for supporting location synchronization in an M2M communication system.

### BACKGROUND OF THE INVENTION

Machine to Machine (M2M) communication indicates communication between an electronic device and an electronic device. In a broad sense, the M2M communication indicates wired or wireless communication between electronic devices or communication between a device controlled by a person and machine. Recently, the M2M communication specifically refers to wireless communication between the electronic device and the electronic device; that is, between the devices.

In the early 1990s when the concept of the M2M communication is initially adopted, it was considered as remote control or telematics and its market was very limited. Recently, the M2M communication market is growing to draw attention all over the world. In particular, the M2M communication originally exerts a great influence on fleet management, remote monitoring of machinery and equipment, and smart meter for automatically measuring a working time, heat, or electric energy of construction machinery equipment in Point of Sales (POS) system and security related application markets. Also, the M2M communication is applied for far more various purposes in association with existing mobile communication, wireless high-speed Internet, and low-power communication solutions such as WiFi and ZigBee.

Meanwhile, new devices having diverse characteristics are recently released, and various application services are introduced based on location information of the new devices such as tablet Personal Computer (PC), smartphone, and notebook. However, not having a function for receiving or generating the location information, all of the devices may not receive the new services based on the location information. That is, to use an application service based on the location information in existing devices, the devices should include a Global Positioning System (GPS) module. Yet, the GPS module is not mounted to every device.

In this respect, a method and an apparatus for supporting the service based on the location synchronization in the devices not including the GPS module in the M2M communication system are required.

### SUMMARY OF THE INVENTION

To address the above-discussed deficiencies of the prior art, it is a primary aspect of the present disclosure to provide a method and an apparatus for supporting a service based on location information in a device not including a GPS module in an M2M communication system.

Another aspect of the present disclosure is to provide a method and an apparatus for synchronizing location information in an M2M communication system.

According to one aspect of the present disclosure, an operating method of a server for synchronizing location information between devices in a Machine to Machine (M2M) communication, system includes when receiving location information synchronization request for a plurality of devices, determining whether there is location information of a corresponding device among the plurality of devices; if there is no location information of the corresponding device, requesting location information to the corresponding device and receiving the location information of the corresponding device; and transmitting the received location information of the corresponding device to the other devices excluding the corresponding device among the plurality of devices.

According to another aspect of the present disclosure, an operating method of a device for synchronizing location information in an M2M communication system includes performing a registration procedure with a management server; and if location information is requested from the management server, transmitting the location information. The location information is synchronized with one or more other devices.

According to yet another aspect of the present disclosure, an operating method of a device for synchronizing location information in an M2M communication system includes performing a registration procedure with a management server; and receiving location information from the management server. The location information is synchronized with one or more other devices.

According to still another aspect of the present disclosure, an apparatus for synchronizing location information between devices in an M2M communication system includes a controller for, when receiving location information synchronization request for plurality of devices, determining whether there is location information of a corresponding device among the plurality of devices, requesting location information to the corresponding device and receiving the location information of the corresponding device if there is no location information of the corresponding device; and an interface for transmitting the received location information of the corresponding device to the other devices excluding the corresponding device among the plurality of devices.

According to a further aspect of the present disclosure, an apparatus for synchronizing location information in an M2M communication system includes a controller for performing a registration procedure with a management server; and a transceiver for, if location information is requested from the management server, transmitting the location information. The location information is synchronized with one or more other devices.

According to a further aspect of the present disclosure, an apparatus of a device for synchronizing location information in an M2M communication system includes a controller for performing a registration procedure with a management server; and a transceiver for receiving location information from the management server. The location information is synchronized with one or more other devices.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an M2M communication system according to an exemplary embodiment of the present disclosure;

FIG. 2 illustrates location information synchronization of devices in the M2M communication system according to one exemplary embodiment of the present disclosure;

FIG. 3 illustrates location information synchronization of devices in the M2M communication system according to another exemplary embodiment of the present disclosure;

FIG. 4 illustrates location information synchronization of devices in the M2M communication system according to yet another exemplary embodiment of the present disclosure;

FIG. 5 illustrates a device management screen according to an exemplary embodiment of the present disclosure;

FIG. 6 illustrates operations of a location information management server for synchronizing the location information of the devices in the M2M communication system according to an exemplary embodiment of the present disclosure;

FIG. 7 illustrates operations of a device management server for synchronizing the location information of the devices in the M2M communication system according to an exemplary embodiment of the present disclosure;

FIG. 8 illustrates operations of a first device for synchronizing the location information of the devices in the M2M communication system according to an exemplary embodiment of the present disclosure;

FIG. 9 illustrates operations of a second device for synchronizing the location information of the devices in the M2M communication system according to an exemplary embodiment of the present disclosure;

FIG. 10 illustrates a server for synchronizing the location information of the devices in the M2M communication system according to an exemplary embodiment of the present disclosure; and

FIG. 11 illustrates an apparatus for synchronizing the location information of the devices in the M2M communication system according to an exemplary embodiment of the present disclosure.

Throughout the drawings, like reference numerals will be understood to refer to like parts, components and structures.

### DETAILED DESCRIPTION OF THE INVENTION

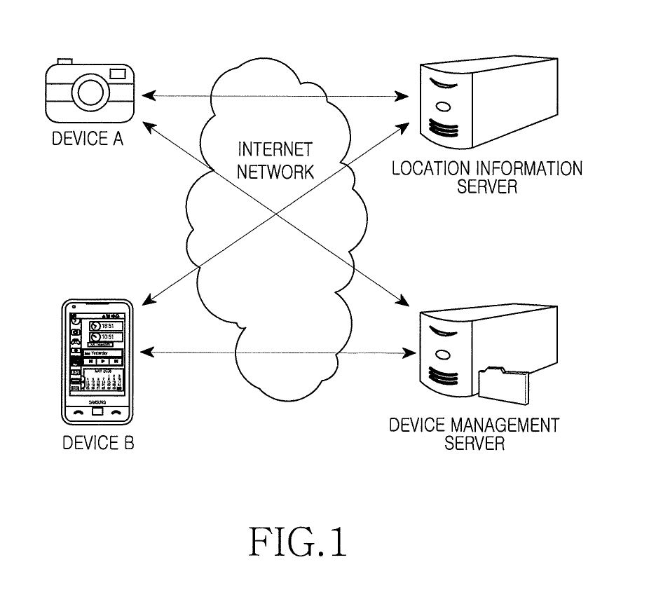

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

Preferred embodiments of the present invention will be described herein below with reference to the accompanying drawings. In the following description, well-known functions or constructions are not described in detail since they would obscure the invention in unnecessary detail. Terms described below, which are defined considering functions in the present invention, may be different depending on user and operator's intention or practice. Therefore, the terms should be defined on the basis of the disclosure throughout this specification.

Exemplary embodiments of the present disclosure provide a method and an apparatus for supporting location information in a Machine to Machine (M2M) communication system. Particularly, the present disclosure provides a technique for devices not including a Global Positioning System (GPS) module to receive location information from a device including a GPS module.

FIG. 1 illustrates an M2M communication system according to an exemplary embodiment of the present disclosure.

Referring to FIG. 1, the M2M communication system includes a location information server, a device management server, a device A including a GPS module, and a device B not including a GPS module. In various exemplary embodiments, the M2M communication system may further include a plurality of devices including the GPS module or a plurality of devices not including the GPS module. The location information server and the device management server may be implemented as a single server.

The device management server registers devices of an individual and manages the devices of the individual as a group. The location information server registers and manages location information of the devices including the GPS module among the devices of the individual, using database.

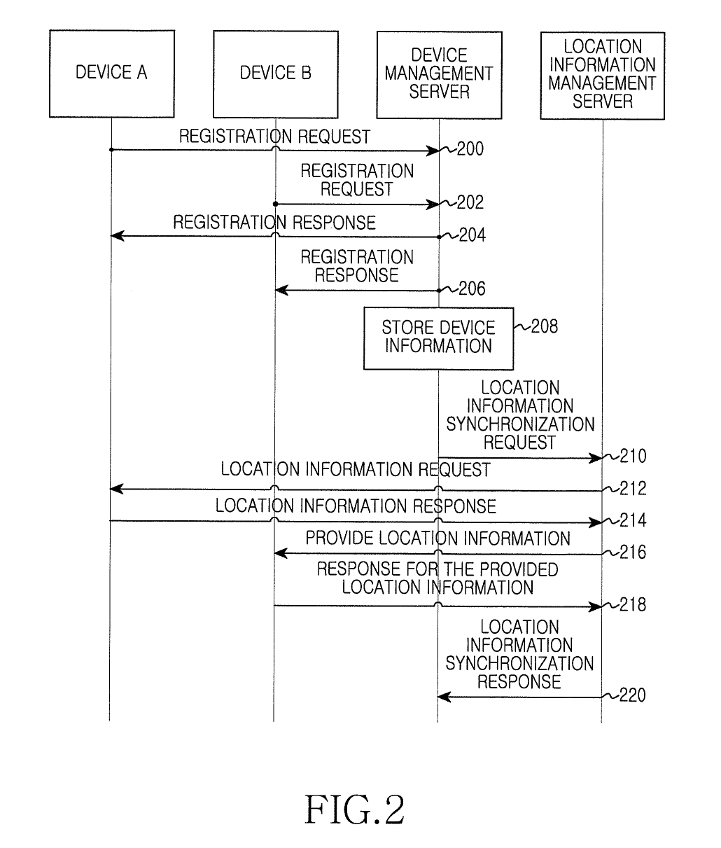

The device A and the device B are electronic devices such as smart phones, notebooks, and home appliances, and may communicate with each other over the Internet network or directly. The device A and the device B are registered to the device management server over the Internet network, which shall be explained by referring to FIGS. 2, 3 and 4.

The device A including the GPS module provides its location information to the location information server on the periodic basis, or provides its location information to the location information server when the location information server requests to. The device B not including the GPS module, when it is positioned in the same place or location of the device A, receives the location information of the device A from the location information server and synchronizes the location with the device A, which shall be explained by referring to FIGS. 2, 3 and 4.

The present disclosure includes 1) registering user devices to the device management server, 2) selecting, by a user, location synchronization in a device management screen, and 3) synchronizing, by the location information server, the location information between the devices.

FIG. 2 illustrates location synchronization of devices in the M2M communication system according to one exemplary embodiment of the present disclosure.

Referring to FIG. 2, user devices are registered to the device management server in steps 200 through 206.

When power is applied to the device A, the device A accesses the Internet network using an address of the device management server stored to the device and then sends a registration request message to the device management server in step 200. The registration request message includes a user identifier, a device identifier for the device A, a serial number, and information of whether the GPS module is mounted. In various implementations, the information of whether the GPS module is mounted may be replaced by device identifier information. That is, since specifications of the corresponding device may be obtained from the device identifier, whether the GPS module is mounted may be determined based on the device identifier.

The device management server sends a registration response message to the device A in step 204.

Likewise, when the power is applied to the device B, the device B accesses the Internet network using the address of the device management server stored to the device and then sends a registration request message to the device management server in step 202. The registration request message includes a user identifier, a device identifier for the device B, a serial number, and information of whether the GPS module is mounted. In various implementations, the information of whether the GPS module is mounted may be replaced by device identifier information. That is, since the specifications of the corresponding device may be obtained from the device identifier, whether the GPS module is mounted may be determined based on the device identifier.

The device management server sends a registration response message to the device B in step 206.

Meanwhile, the device management server stores the device information of the device A and the device B received in steps 200 and 202 to its database in step 208.

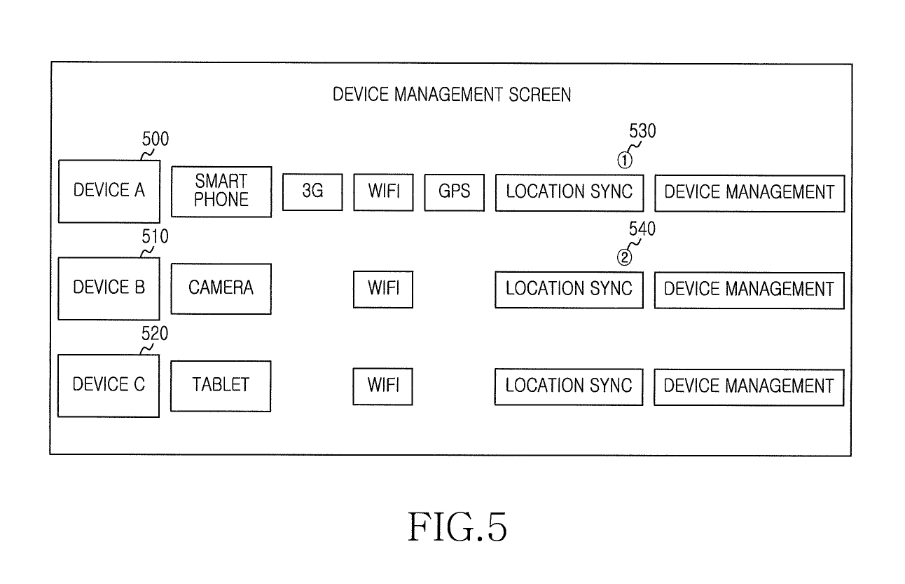

When the user selects location synchronization menu in a device management screen (a screen of a display connected to the device management server), the device management server requests location information synchronization to the location information management server in step 210. The device management screen is shown in FIG. 5.

That is, when the user selects two or more (e.g., a plurality of) devices (the device A and the device B) to synchronize the location information through the device management screen of the device management server, the device management server sends a location information synchronization request message to the location information management server.

Upon receiving the location information synchronization request from the device management server, the location information management server synchronizes the location information between the devices in steps 212 through 220.

In detail, the location information management server receives the location information synchronization request between the multiple devices from the device management server, and checks whether there is the location information of the devices currently requested in step 212. When there is no location information, the location information management server sends a location information request message to the device A. When there is the location information of the device A including the GPS module, steps 212 and 214 are not conducted.

The device A sends a location information response message including its location information to the location information management server in step 214.

The location information management server provides the location information of the device A to the device B not including the GPS module in step 216.

The device B sends a response message to the location information management server in response to the provided location information in step 218.

The location information management server sends to the device management server a location information synchronization response message informing that the location information of the device A and the device B is successfully synchronized in step 220. The device management server stores the location information synchronization of the device A and the device B to the database. When the device management screen is displayed, the device management server informs the user that the device A and the device B are synchronized, in the screen.

As such, while the device B not including the GPS module is synchronized to the location information of the device A including the GPS module, the device B including the GPS module may be synchronized to the location information of the device A in various implementations. In one example, when the device A requests the registration in step 200 and transmits its location information at the same time, steps 212 and 214 may not be carried out and the location information management server may forward the location information of the device A received in step 200 to the device B immediately.

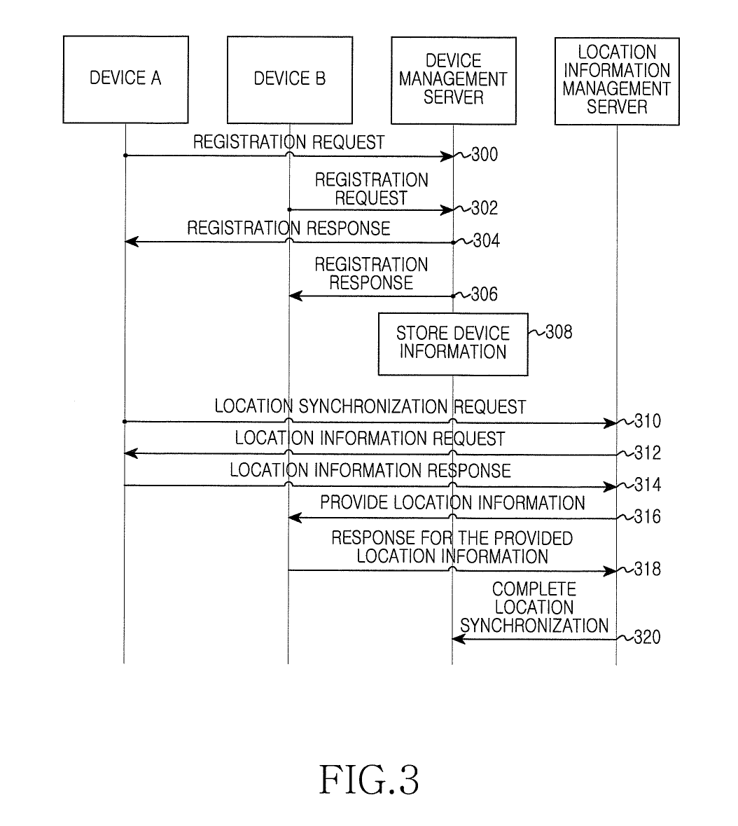

FIG. 3 illustrates location information synchronization of the devices in the M2M communication system according to another exemplary embodiment of the present disclosure.

Referring to FIG. 3, steps 300 through 306 register the user devices to the device management server (e.g., in a manner similar to the registration procedure of FIG. 2).

When the power is applied to the device A, the device A accesses the Internet network using the address of the device management server stored to the device and then sends a registration request message to the device management server in step 300. The registration request message includes the user identifier, the device identifier for the device A, the serial number, and the information of whether the GPS module is mounted. In various implementations, the information of whether the GPS module is mounted may be replaced by the device identifier information. That is, since the specifications of the corresponding device may be obtained from the device identifier, whether the GPS module is mounted may be determined based on the device identifier.

The device management server sends a registration response message to the device A in step 304.

Likewise, when the power is applied to the device B, the device B accesses the Internet network using the address of the device management server stored to the device and then sends a registration request message to the device management server in step 302. The registration request message includes the user identifier, the device identifier for the device B, the serial number, and the information of whether the GPS module is mounted. In various implementations, the information of whether the GPS module is mounted may be replaced by the device identifier information. That is, since the specifications of the corresponding device may be obtained from the device identifier, whether the GPS module is mounted may be determined based on the device identifier.

The device management server sends a registration response message to the device B in step 306.

Meanwhile, the device management server stores the device information of the device A and the device B received in steps 300 and 302 to its database in step 308.

When the user selects the location synchronization in the device management screen (the screen of the display connected to the device management server), the device A requests the location information synchronization to the location information management server in step 310. The device management screen is shown in FIG. 5.

That is, when the user selects two or more devices (the device A and the device B) to synchronize the location information through the device management screen of the device A, the device A sends a location information synchronization request message to the location information management server. In various implementations, the device A may send the location information synchronization request message to the location information management server via the device management server. That is, the device management server may forward the location information synchronization request message of the device A to the location information management server.

Upon receiving the location information synchronization request from the device A, the location information management server synchronizes the location information between the devices in steps 312 through 320.

In detail, after receiving the location information synchronization request between the multiple devices from the device A, the location information management server checks whether there is the location information of the devices currently requested in step 312. When there is no location information, the location information management server sends a location information request message to the device A including the GPS module. When there is the location information of the device A including the GPS module, steps 312 and 314 are not conducted.

The device A sends a location information response message including its location information to the location information management server in step 314.

The location information management server provides the location information of the device A to the device B not including the GPS module in step 316.

The device B sends a response message to the location information management server in response to the provided location information in step 318.

Next, the location information management server sends to the device management server a location information synchronization response message informing that the location information of the device A and the device B is successfully synchronized in step 320. The device management server stores the location information synchronization of the device A and the device B to the database. When the device management screen is displayed, the device management server informs the user that the device A and the device B are synchronized, in the screen.

As such, while the device B not including the GPS module is synchronized to the location information of the device A including the GPS module, the device B including the GPS module may be synchronized to the location information of the device A in various implementations. In one example, when the device A requests the registration in step 300 and transmits its location information at the same time, steps 312 and 314 may not be carried out and the location information management server may forward the location information of the device A received in step 300 to the device B immediately.

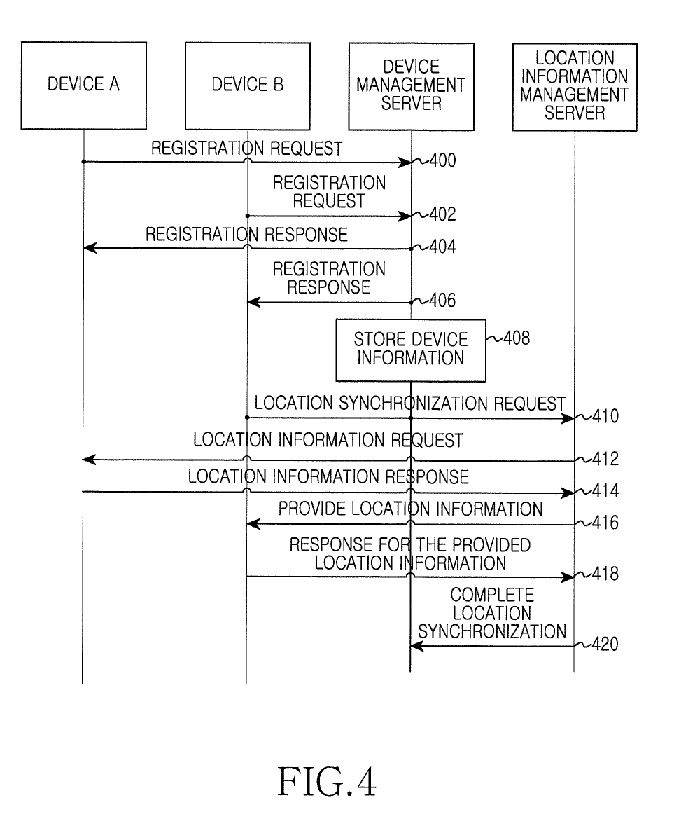

FIG. 4 illustrates location information synchronization of devices in the M2M communication system according to yet another exemplary embodiment of the present disclosure.

Referring to FIG. 4, steps 400 through 406 register the user devices to the device management server (e.g. in a manner similar to the registration procedure of FIG. 3).

When the power is applied to the device A, the device A accesses the Internet network using the address of the device management server stored to the device and then sends a registration request message to the device management server in step 400. The registration request message includes the user identifier, the device identifier for the device A, the serial number, and the information of whether the GPS module is mounted. In various implementations, the information of whether the GPS module is mounted may be replaced by the device identifier information. That is, since the specifications of the corresponding device may be obtained from the device identifier, whether the GPS module is mounted may be determined based on the device identifier.

The device management server sends a registration response message to the device A in step 404.

Likewise, when the power is applied to the device B, the device B accesses the Internet network using the address of the device management server stored to the device and then sends a registration request message to the device management server in step 402. The registration request message includes the user identifier, the device identifier for the device B, the serial number, and the information of whether the GPS module is mounted. In various implementations, the information of whether the GPS module is mounted may be replaced by the device identifier information. That is, since the specifications of the corresponding device may be obtained from the device identifier, whether the UPS module is mounted may be determined based on the device identifier.

The device management server sends a registration response message to the device B in step 406.

Meanwhile, the device management server stores the device information of the device A and the device B received in steps 400 and 402 to its database in step 408.

When the user selects the location synchronization in the device management screen (the screen of the display connected to the device management server), the device B requests the location information synchronization to the location information management server in step 410. The device management screen is shown in FIG. 5.

That is, when the user selects two or more devices (the device A and the device B) to synchronize the location information through the device management screen of the device B, the device B sends a location information synchronization request message to the location information management server. In various implementations, the device B may send the location information synchronization request message to the location information management server via the device management server. That is, the device management server may forward the location information synchronization request message of the device B to the location information management server.

Upon receiving the location information synchronization request from the device B, the location information management server synchronizes the location information between the devices in steps 412 through 420.

In detail, after receiving the location information synchronization request of the multiple devices from the device B, the location information management server_checks whether there is the location information of the devices currently requested in step 412. When there is no location information, the location information management server sends a location information request message to the device A including the GPS module. When there is the location information of the device A including the GPS module, steps 412 and 414 are not conducted.

The device A sends a location information response message including its location information to the location information management server in step 414.

The location information management server provides the location information of the device A to the device B not including the GPS module in step 416.

The device B sends a response message to the location information management server in response to the provided location information in step 418.

Next, the location information management server sends to the device management server a location information synchronization response message informing that the location information of the device A and the device B is successfully synchronized in step 420. In so doing, the device management server stores the location information synchronization of the device A and the device B to the database. When the device management screen is displayed, the device management server informs the user that the device A and the device B are synchronized, in the screen.

In various implementations, when the device A transmits its location information while requesting the registration in step 400, steps 412 and 414 may not be conducted and the location information management server may forward the location information of the device A received in step 400 to the device B immediately.

FIG. 5 depicts the device management screen according to an exemplary embodiment of the present disclosure.

Referring to FIG. 5, the user may utilize user interface of the device through a menu of the device (the device management server, the device A, or the device B) or through the access to a particular webpage address.

The user may identify all of his/her registered devices through the device management screen, and confirm characteristics of the devices. For example, a smartphone (a device A) 500 has 3G and WiFi communication capabilities and may generate the location information using the embedded GPS module. A camera (a device B) 510 and a tablet (a device C) 520 have the WiFi communication capability and do not include the GPS module.

When determining based on the device management screen that it is necessary to synchronize the location information between the camera not including the GPS module and the smartphone including the GPS module, the user selects location sync buttons 530 and 540 in the user interface. That is, when the smartphone and the camera are in the same place, the user may synchronize the location information of the smartphone 500 and the camera 510. In various implementations, two or more devices may be selected for the synchronization.

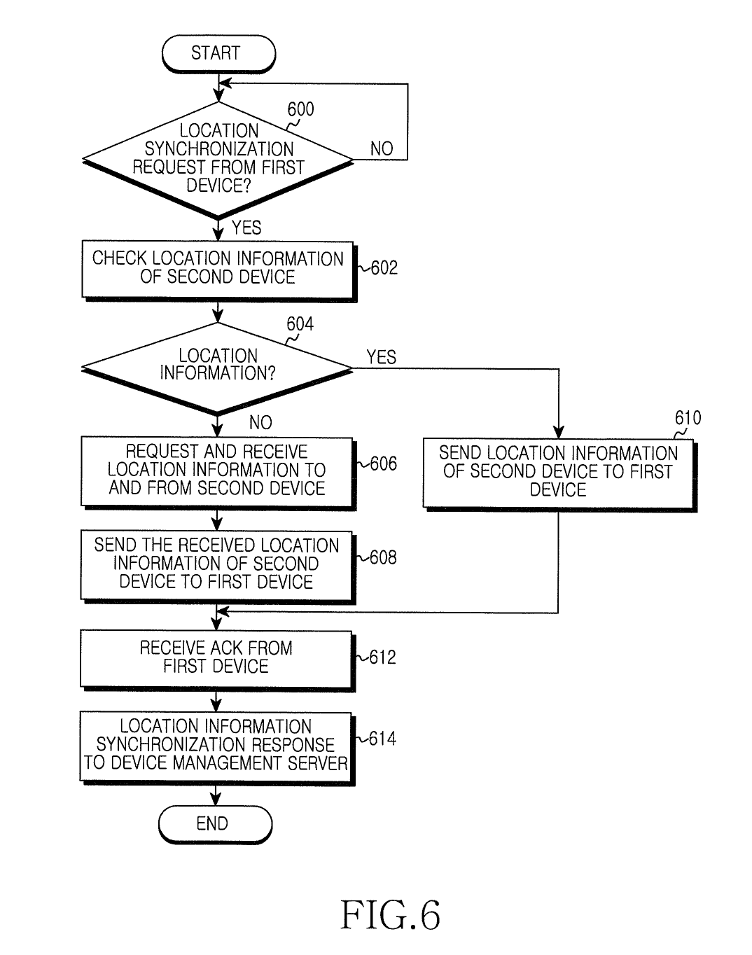

FIG. 6 illustrates operations of the location information management server for synchronizing the location information of the devices in the M2M communication system according to an exemplary embodiment of the present disclosure.

Referring to FIG. 6, when the device management server, the device including the GPS module (referred to as a second device), or the device not including the GPS module (referred to as a first device) requests the location information synchronization for the first device and the second device in step 600, the location information management server checks whether the database contains the location information of the second device in step 602.

When there is no location information of the second device in step 604, the location information management server requests and receives the location information to and from the second device in step 606 and forwards the location information received from the second device to the first device in step 608.

By contrast, when the database contains the location information of the second device in step 602, the location information management server reads the location information of the second device from the database and transmits the location information to the first device in step 610.

Next, the location information management server receives an Acknowledge (ACK) message from the first device in step 612 and informs the device management server that the location information of the first device and the second device is synchronized in step 614.

Next, the location information management server finishes this process.

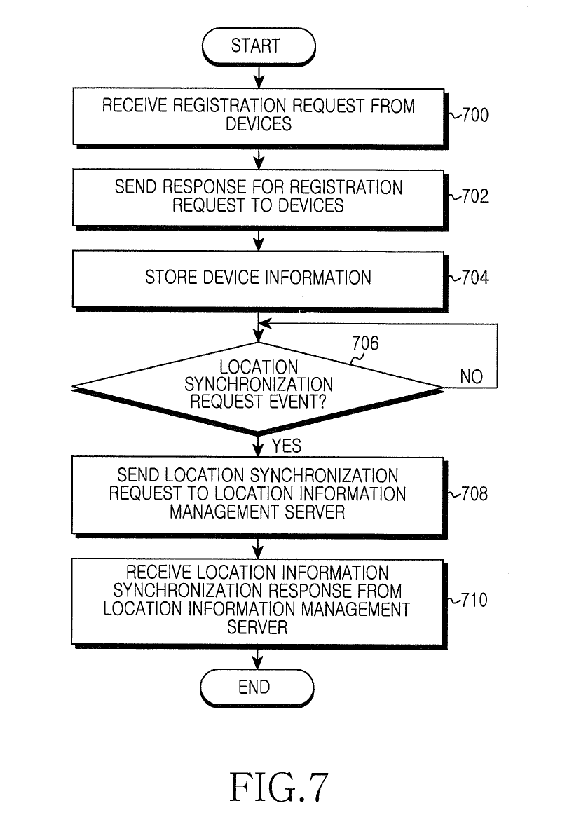

FIG. 7 illustrates operations of the device management server for synchronizing the location information of the devices in the M2M communication system according to an exemplary embodiment of the present disclosure.

Referring to FIG. 7, the device management server receives the registration request messages from the corresponding devices in step 700 and sends the registration response message to the corresponding devices in step 702.

In step 704, the device management server stores the device information of the registration request messages of the corresponding devices to the database.

When a location information synchronization request event takes place; that is, when the user requests the location information synchronization between the corresponding devices through the device management screen of the device management server in step 706, the device management server requests the location information synchronization to the location information management server in step 708.

In step 710, the device management server is informed by the location information management server that the location information synchronization between the corresponding devices is completed. In so doing, the device management server may store the location information synchronization completion information of the corresponding devices to the database and then inform the user of the location information synchronization between the corresponding devices through the device management screen.

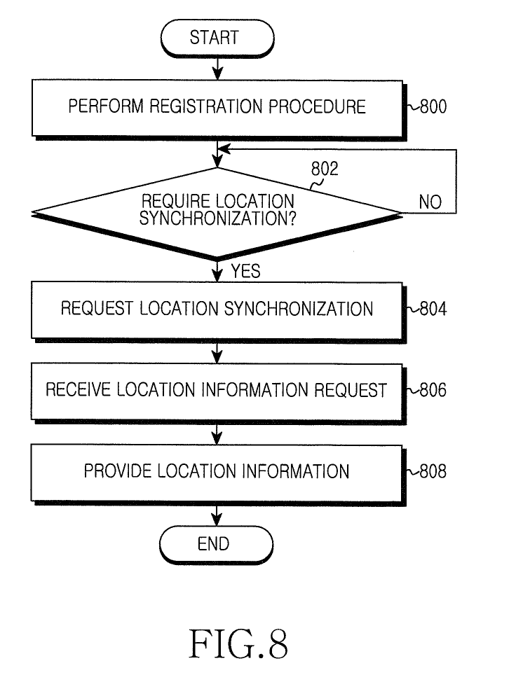

FIG. 8 illustrates operations of the first device for synchronizing the location information of the devices in the M2M communication system according to an exemplary embodiment of the present disclosure.

Referring to FIG. 8, the first device performs the registration request procedure with the device management server in step 800.

When the location synchronization is necessary; that is, when the user requests the location information synchronization between the corresponding devices (e.g., the first device and the second device) through the device management screen of the first device in step 802, the first device requests the location information synchronization to the location information management server in step 804.

The first device receives the location information request from the location information management server in step 806 and provides its location information to the location information management server in step 808.

Next, the first device finishes this process.

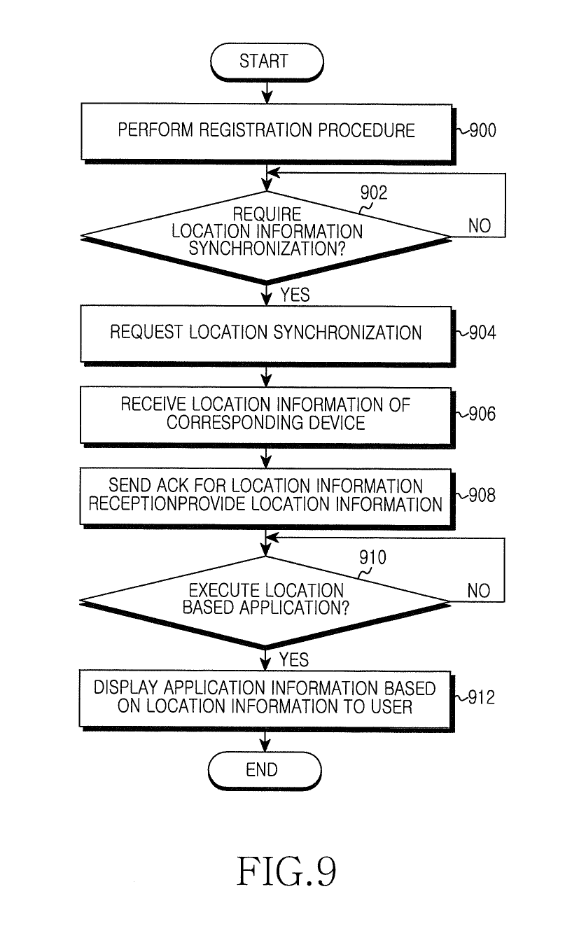

FIG. 9 illustrates operations of the second device for synchronizing the location information of the devices in the M2M communication system according to an exemplary embodiment of the present disclosure.

Referring to FIG. 9, the second device performs the registration request procedure with the device management server in step 900.

When the location synchronization is required; that is, when the user requests the location information synchronization between the corresponding devices (e.g., the first device and the second device) through the device management screen of the second device in step 902, the second device requests the location information synchronization to the location information management server in step 904.

The second device receives the location information of the first device from the location information management server in step 906, and sends an ACK message for the location information reception in step 908.

When a location based application is executed in step 910, the second device displays application information based on the location information to the user in step 912. The user controls the second device based on the application information.

For example, when the camera is synchronized based on the location information, the camera directly informs the user of particular location, direction, and composition of a picture taken by a famous photographer so that a general camera user may produce the same result as the picture of the famous photographer.

The user may directly know the location such as photo spot, for the best picture in a certain tourist spot. When the user gets close to the corresponding photo spot, camera manipulations for taking the best picture may be informed to the user.

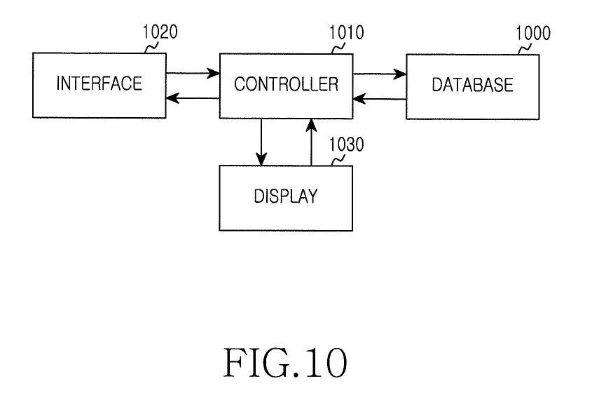

FIG. 10 illustrates a server for synchronizing the location information of the devices in the M2M communication system according to an exemplary embodiment of the present disclosure.

Referring to FIG. 10, the server includes an interface 1020, a controller 1010, a database 1000, and a display 1030.

The interface 1020 is connected to the backbone network, receives the message from the device over the Internet network, and provides the received message to the controller 1010. The interface 1020 receives data from the controller 1010 and transmits the data to the corresponding device.

The controller 1010 controls the operations of the server. In particular, the controller 1010 registers and manages the corresponding devices, registers the location information of the corresponding device, and controls the location information synchronization between the devices if necessary.

For example, when the location information synchronization event takes place, the controller 1010 checks whether the database 1000 contains the location information of the first device, transmits the location information of the first device to the second device, and thus synchronizes the location information of the first device and the second device.

The database 1000, which is a storage device, contains microcodes and reference data of programs for the processing and the controlling of the controller 1010, temporary data generating in the program executions, and updatable storage data. In addition, the database 1000 stores the device information and the location information received from the corresponding devices, and provides the device information and the location information when the controller 1010 requests to.

The display 1030 displays the information output from the controller 1010. For example, the display 1030 generates the device management screen of FIG. 5 using the device information output from the controller 1010. Herein, the display 1030 may employ a Liquid Crystal Display (LCD).

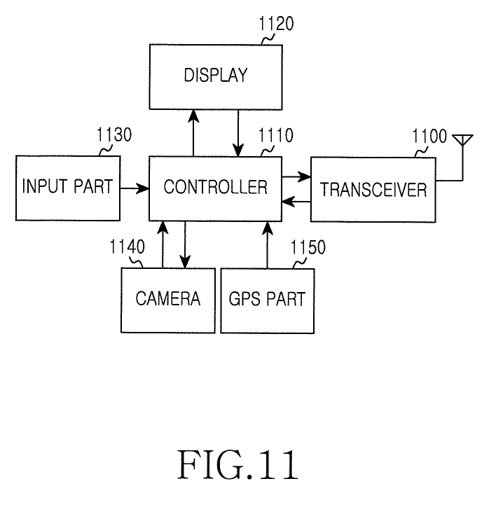

FIG. 11 illustrates an apparatus for synchronizing the location information of the devices in the M2M communication system according to an exemplary embodiment of the present disclosure.

Referring to FIG. 11, the apparatus includes a transceiver 1100, a controller 1110, a display 1120, an input part 1130, a camera 1140, and a GPS part 1150.

The transceiver 1100 transmits and receives data to and from the server over the Internet network based on the corresponding interface standard (WiFi or 3G).

The controller 1110 controls the operations of the apparatus. In addition, the controller 1110 performs the registration request procedure with the corresponding server, and requests the location information synchronization to the corresponding server when the location synchronization with the corresponding devices is required. When receiving the location information request from the corresponding server, the controller 1110 provides its location information to the corresponding server.

When the location based application is executed, the controller 1110 displays the application information based on the location information to the user through the display 1120.

The display 1120 displays state information and a limited number of characters generating in the operations of the apparatus. In addition, the display 1120 displays the device management screen of FIG. 5 using the device information output from the controller 1110. In various implementations, the display 1120 may be formed as a touch panel and function as the input part 1130. That is, the display 1120 detects and sends user's touch input to the controller 1110.

The input part 1130 includes a plurality of function key buttons and provides key button input data corresponding to the key button pressed by the user to the controller 1110.

The camera 1140 provides the captured image or video to the controller 1110 under the control of the controller 1110. The GPS part 1150 measures and provides the location to the controller 1110 on the periodic basis or according to the request of the controller 1110.

As set forth above, the device including the GPS module and the devices not including the GPS module synchronize their location information via the server in the M2M communication system. Therefore, all of the devices of the individual may use various services based on the location information.

While the invention has been shown and described with reference to certain exemplary embodiments thereof, it will be understood by those skilled in the art that various changes in foul' and details may be made therein without departing from the spirit and scope of the invention as defined by the appended claims and their equivalents.

What is claimed is:

1. A method of a server for synchronizing location information between devices in a Machine to Machine (M2M) communication system, the method comprising:
when receiving a location information synchronization request for a plurality of devices, determining whether location information of a corresponding device among the plurality of devices is present;
if the location information of the corresponding device is not present, requesting location information from the corresponding device and receiving the location information of the corresponding device; and
transmitting the received location information of the corresponding device to other devices excluding the corresponding device among the plurality of devices.

2. The method of claim 1 further comprising:
if the location information of the corresponding device is present, reading the location information of the corresponding device from a database and transmitting the read location information of the corresponding device to the other devices excluding the corresponding device among the plurality of devices.

3. The method of claim 1, wherein the corresponding device comprises a Global Positioning System (GPS) module.

4. The method of claim 1, wherein the location information synchronization request for the plurality of devices is one of requested directly through a user interface of the server and requested according to a request from one of the plurality of devices.

5. The method of claim 1 further comprising:
after transmitting the received location information of the corresponding device, storing a location information synchronization result of the plurality of devices and displaying the location information synchronization of the plurality of devices on one of the plurality of devices.

6. The method of claim 1 further comprising:
after transmitting the received location information of the corresponding device, transmitting a location information synchronization result of the plurality of devices to the other devices excluding the corresponding device among the plurality of devices.

7. The method of claim 1 further comprising:
receiving a registration request message from the plurality of devices;
transmitting a registration response message to the plurality of devices; and
storing information of the plurality of devices to the database.

8. The method of claim 7, wherein the registration request message comprises at least one of a user identifier, a device identifier, a serial number, location information, and information of whether a GPS function is performed.

9. A method of a device for synchronizing location information in a Machine to Machine (M2M) communication system, the method comprising:
performing a registration procedure with a management server; and
if location information is requested from the management server, transmitting the location information,
wherein the location information is synchronized with at least one other device.

10. The method of claim 9, wherein performing the registration procedure with the management server comprises:
transmitting a registration request message to the management server; and
receiving a registration response message from the management server.

11. The method of claim 10, wherein the registration request message comprises at least one of a user identifier, a device identifier, a serial number, location information, and information of whether a GPS function is performed.

12. The method of claim 9 further comprising:
requesting a location information synchronization with the at least one other device, to the management server.

13. The method of claim 12, wherein requesting the location information synchronization with the at least one other device to the management server is performed through a user interface.

14. The method of claim 11 further comprising:
receiving, from the management server, a location information synchronization result with the at least one other device.

15. A method of a device for synchronizing location information in a Machine to Machine (M2M) communication system, the method comprising:
performing a registration procedure with a management server; and
receiving location information from the management server,
wherein the location information is synchronized with at least one other device.

16. The method of claim 15, wherein performing the registration procedure with the management server comprises:
transmitting a registration request message to the management server; and
receiving a registration response message from the management server.

17. The method of claim 16, wherein the registration request message comprises at least one of a user identifier, a device identifier, a serial number, location information, and information of whether a Global Positioning System (GPS) function is performed.

18. The method of claim 15 further comprising:
requesting a location information synchronization with the at least one other device, to the management server.

19. The method of claim 18, wherein requesting the location information synchronization with the at least one other device to the management server is performed through a user interface.

20. The method of claim 15 further comprising:
receiving, from the management server, a location information synchronization result with the at least one other device.

21. The method of claim 15 further comprising:
after receiving the location information from the management server, executing a corresponding application using the location information;
generating control information corresponding to the location information through the application; and
displaying the control information on the device.

22. The method of claim 15 further comprising:
after receiving the location information from the management server, executing a corresponding application using the location information;
generating, control information corresponding to the location information through the application; and
controlling the device based on the control information.

23. An apparatus for synchronizing location information between devices in a Machine to Machine (M2M) communication system, the apparatus comprising:
a controller configured to, when receiving a location information synchronization request for a plurality of devices, determine whether location information of a corresponding device among the plurality of devices is present, request location information to the corresponding device, and receive the location information of the corresponding device if the location information of the corresponding device is not present; and
an interface configured to transmit the received location information of the corresponding device to other devices excluding the corresponding device among the plurality of devices.

24. The apparatus of claim 23, wherein, if the location information of the corresponding device is present, the controller is further configured to read the location information of the corresponding device from a database and transmit the read location information of the corresponding device to the other devices excluding the corresponding device among the plurality of devices.

25. The apparatus of claim 23, wherein the corresponding device comprises a Global Positioning System (GPS) module.

26. The apparatus of claim 23, wherein the location information synchronization request for the plurality of devices is one of requested directly through a user interface of a server and requested according to a request from one of the plurality of devices.

27. The apparatus of claim 23, wherein, after transmitting the received location information of the corresponding device, the controller is further configured to store a location information synchronization result of the plurality of devices and display the location information synchronization of the plurality of devices on one of the plurality of devices.

28. The apparatus of claim 23, wherein, after transmitting the received location information of the corresponding device, the controller is further configured to transmit a location information synchronization result of the plurality of devices to the other devices excluding, the corresponding device among, the plurality of devices.

29. The apparatus of claim 23 further comprising:
a transceiver configured to receive a registration request message from the plurality of devices and transmit a registration response message to the plurality of devices; and
a database configured to store information of the plurality of devices.

30. The apparatus of claim 29, wherein the registration request message comprises at least one of a user identifier, a device identifier, a serial number, location information, and information of whether a GPS function is performed.

31. An apparatus for synchronizing location information in a Machine to Machine (M2M) communication system, the apparatus comprising:
a controller configured to perform a registration procedure with a management server; and
a transceiver configured to, if location information is requested from the management server, transmit the location information,
wherein the location information is synchronized with at least one other device.

32. The apparatus of claim 31, wherein the controller is further configured to transmit a registration request message to the management server and receive a registration response message from the management server.

33. The apparatus of claim 32, wherein the registration request message comprises at least one of a user identifier, a device identifier, a serial number, location information, and information of whether a Global Positioning System (GPS) function is performed.

34. The apparatus of claim 31, wherein the controller is further configured to request location information synchronization with the at least one other device, to the management server.

35. The apparatus of claim 34, wherein the requesting of the location information synchronization with the at least one other device is performed through a user interface.

36. The apparatus of claim 31, wherein the controller is further configured to receive from the management server, a location information synchronization result with the at least one other device.

37. An apparatus of a device for synchronizing location information in a Machine to Machine (M2M) communication system, the apparatus comprising:
a controller configured to perform a registration procedure with a management server; and
a transceiver configured to receive location information from the management server,
wherein the location information is synchronized with at least one other device.

38. The apparatus of claim 37, wherein the controller is further configured to transmit a registration request message to the management server and receive a registration response message from the management server.

39. The apparatus of claim 38, wherein the registration request message comprises at least one of a user identifier, a device identifier, a serial number, location information, and information of whether a Global Positioning System (GPS) function is performed.

40. The apparatus of claim 37, wherein the controller is further configured to request a location information synchronization with the at least one other device, to the management server.

41. The apparatus of claim 40, wherein the location information synchronization with the other device is requested through a user interface.

42. The apparatus of claim 37, wherein the controller is further configured to receive, from the management server, a location information synchronization result with the at least one other device.

43. The apparatus of claim 37, wherein, after receiving the location information from the management server, the controller is further configured to execute a corresponding application using the location information, generate control information corresponding to the location information through the application, and display the control information to a user.

44. The apparatus of claim 37, wherein, after receiving the location information from the management server, the controller is further configured to execute a corresponding application using the location information, generate control information corresponding to the location information through the application, and control the device based on the control information.
